(19) United States
(12) Patent Application Publication
(10) Pub. No.: US 2005/0195369 A1
(43) Pub. Date: Sep. 8, 2005

(54) Optical element and projection image display apparatus using the same

(76) Inventors: Kazuo Shikita, Yokohama (JP); Tokikuni Nakayama, Chofu (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/063,991

(22) Filed: Feb. 24, 2005

(30) Foreign Application Priority Data
Mar. 3, 2004 (JP) 2004-059623

(51) Int. Cl. G03B 21/14

(52) U.S. Cl. 353/20

(57) ABSTRACT

Increases in temperature of the optical elements arrange in a projection-type image display apparatus are suppressed and high contrast is ensured.

A polarizing element is disposed as a polarizer on least at either one of the light-incident side and light-exit side of an image display element in order to permit, among all polarized R, G, B color light components, only those with desired polarization directivity to pass through. More specifically, the polarizing element is disposed on a light-transmissive substrate having a cubic structure, e.g., a substrate that contains magnesium oxide and whose thickness ranges from about 0.4×10⁻³ to about 1.5×10⁻³ m. Also, a viewing-angle compensating element that compensates for phase differences of the polarized light incident on or exiting from the image display element is disposed between the polarizing element and the image display element. The viewing-angle compensating element uses a viewing-angle compensating film disposed on a light-transmissive substrate having a cubic structure, e.g., a substrate that contains magnesium oxide.

### CLAIM OF PRIORITY

The present application claims priority from Japanese application serial no. P2004-059623, filed on Mar. 3, 2004, the content of which is hereby incorporated by reference into this application.

### BACKGROUND OF THE INVENTION

The present invention relates to the field of projection-type image display, and more particularly, to a technique for ensuring high-contrast image quality.

Examples of the conventional art related to the present invention include one set forth in Japanese Patent Laid-open No. 2002-182213, which describes the following configuration:

A projection-type image display apparatus includes a polarizing plate and an optical compensating element disposed on both sides thereof. This element compensates for the optical phase difference caused by the liquid-crystal molecules of a liquid-crystal display element. Phase adjustments inside a plane orthogonal to the optical axis of the light incident on the liquid-crystal display element are conducted using the optical compensating element, and the optical axis thereof is aligned with the rubbing direction of the liquid-crystal display element. This improves black-level display characteristics for better contrast.

### SUMMARY OF THE INVENTION

In the related art mentioned above, no consideration is given to cooling of the polarizing plate and the optical compensating element.

In view of the above situation in the related art, the present invention is intended to ensure high contrast in a projection-type image display apparatus and to suppress increases in the temperatures of polarizing means (polarizing plate), viewing-angle compensating means, and other optical elements.

An object of the present invention is to provide a projection-type image display technique for solving the above-mentioned problem and allowing high reliability and high image quality to be realized.

In order to solve the above problem, the present invention takes a configuration in which the polarizing means disposed at least on the light-incident side and/or light-exit side of an image display element and transmitting, among all polarized R/G/B color light components, only those endowed with desired polarization directivity, includes a polarizing element disposed on such a cubic-structured light-transmissive substrate as containing magnesium oxide and having a thickness from about 0.4×10⁻³ to about 1.5×10⁻³ m. In addition, viewing-angle compensating means for compensating for any differences in the phase of the polarized light entering or exiting the image display element is provided between the polarizing means and the image display element. The viewing-angle compensating means includes a viewing-angle compensating film disposed on a cubic-structured light-transmissive substrate such as a light-transmissive substrate that contains magnesium oxide. Because of its heat-releasing property, the cubic-structured light-transmissive substrate, i.e., the magnesium-oxide-containing light-transmissive substrate or the like, suppresses increases in the temperatures of the polarizing means and the viewing-angle compensating means, and ensures image contrast of a desired level.

According to the present invention, it is possible to suppress increases in the temperatures of optical elements and ensure high contrast in a projection-type image display apparatus.

### BRIEF DESCRIPTION OF THE DRAWINGS

FIG. 1 is a diagram showing a configurational example of polarizing means in a first embodiment;

FIG. 2 is a block diagram showing a configurational example of the projection-type image display apparatus employing the polarizing means of FIG. 1;

FIG. 3 is a diagram showing an example of the contrast and temperature characteristics of the polarizing means with respect to a substrate thickness thereof;

FIG. 4 is a diagram showing a first combination configurational example of polarizing means and viewing-angle compensating means in a second embodiment;

FIG. 5 is a diagram showing an example of the contrast characteristics of a viewing-angle compensating film with respect to the amount of optical-axis misalignment thereof;

FIG. 6 is a diagram showing a second combination configurational example of polarizing means and viewing-angle compensating means in the second embodiment; and

FIG. 7 is a diagram showing a third combination configurational example of polarizing means and viewing-angle compensating means in the second embodiment.

### DETAILED DESCRIPTION OF THE PREFERRED DRAWINGS

Preferred embodiments of the present invention are described below using the accompanying drawings.

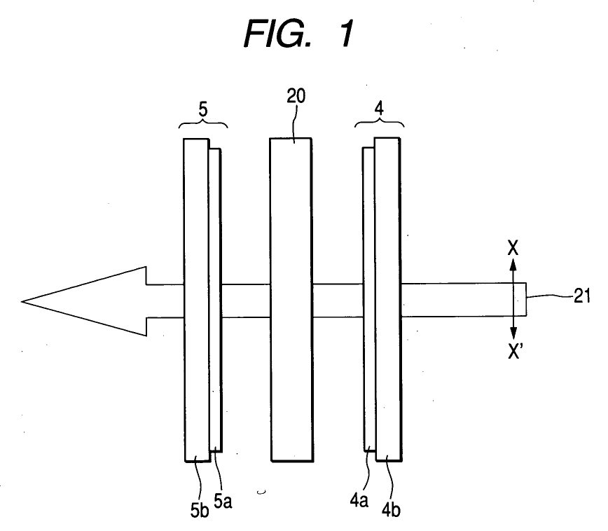

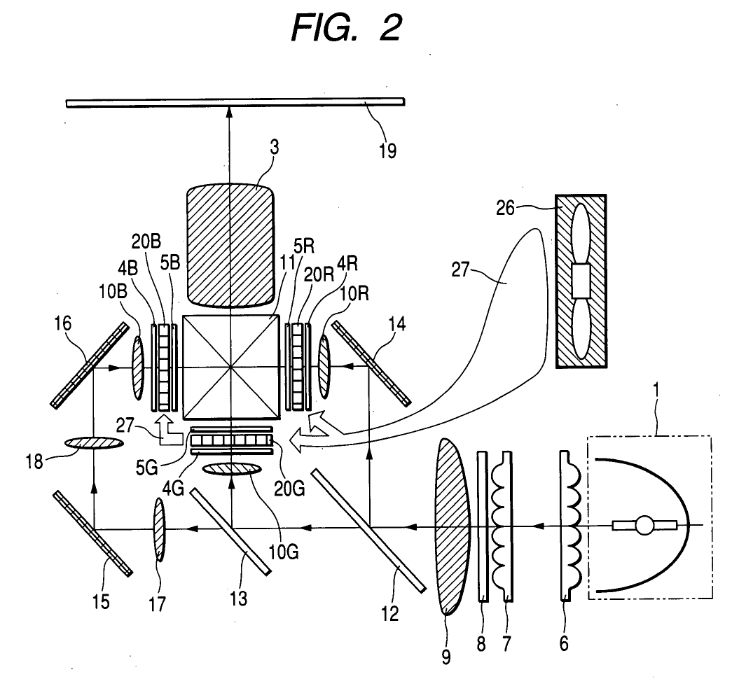

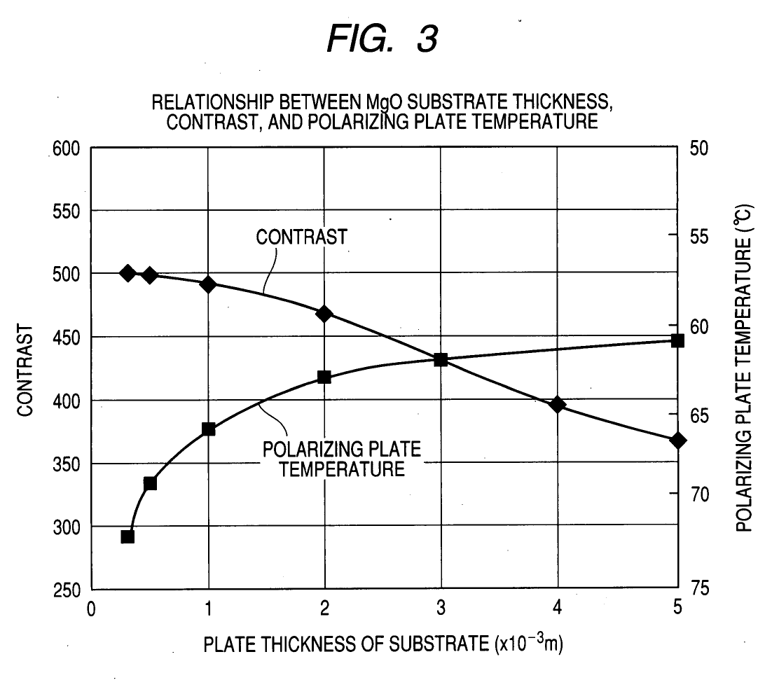

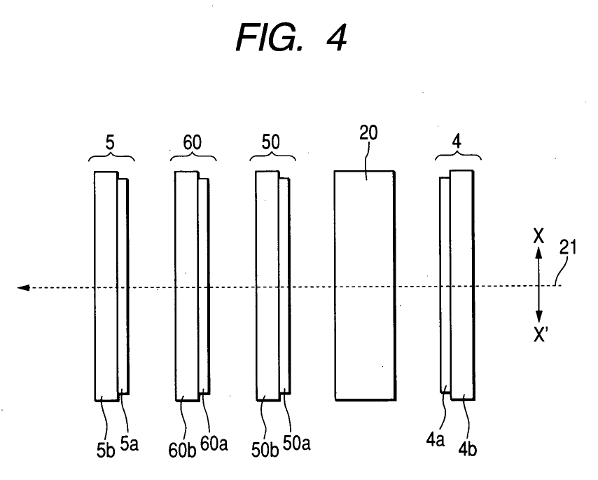

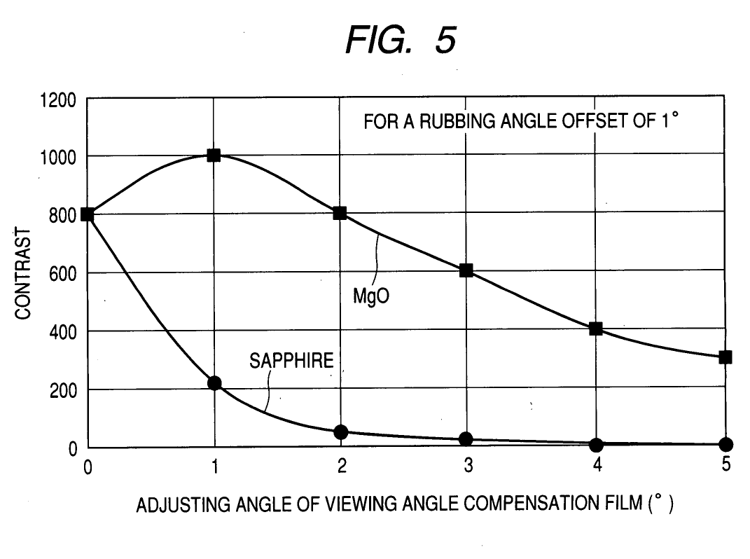

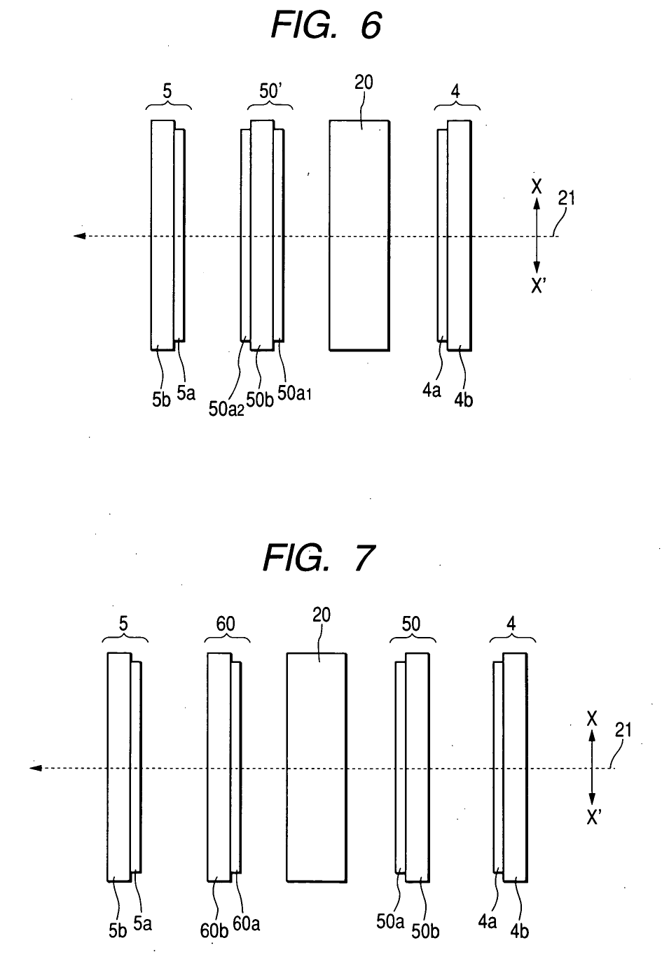

FIGS. 1 to 7 are diagrams that explain the preferred embodiments of the present invention. FIGS. 1 to 3 are explanatory diagrams of a first embodiment, and FIGS. 4 to 7 are explanatory diagrams of a second embodiment. FIG. 1 is a diagram showing a configurational example of polarizing elements. FIG. 2 is a diagram showing a configurational example of the projection-type image display apparatus employing the polarizing elements of FIG. 1. FIG. 3 is a diagram representing a relationship between contrast and temperature characteristics of a polarizing element with respect to a substrate thickness thereof. FIG. 4 is a diagram showing a first combination configurational example of polarizing elements and viewing-angle compensating elements. FIG. 5 is a diagram showing an example of the contrast characteristics of a viewing-angle compensating film with respect to the amount of optical-axis misalignment thereof. FIG. 6 is a diagram showing a second combination configurational example of polarizing elements and viewing-angle compensating elements. FIG. 7 is a diagram showing a third combination configurational example of polarizing elements and viewing-angle compensating elements.

In FIG. 1, reference number 4 denotes an incident-light polarizing plate functioning as a polarizing means, and 5, an exit-light polarizing plate functioning as another polarizing means. Reference number 4a denotes a polarizing film serving as a polarizing element of the incident-light polarizing plate 4 in order to transmit, among all polarized color light components, only those endowed with desired polarization directivity. Reference number 4b denotes a substrate of the incident-light polarizing plate 4. The substrate 4b, a light-transmissive substrate having a cubic structure, is made of a material that contains magnesium oxide, and holds the-polarizing film 4a (hereinafter, the substrate 4b is referred to as the magnesium oxide substrate 4b). Reference number 5a denotes a polarizing film serving as a polarizing element of the exit-light polarizing element 5 in order to transmit, among all polarized color light components, only those endowed with desired polarization directivity. Reference number 5b denotes a substrate of the exit-light polarizing plate 5. The substrate 5b, a light-transmissive substrate having a cubic structure, is made of a material that contains magnesium oxide, and holds the polarizing film 5a (hereinafter, the substrate 5b is referred to as the magnesium oxide substrate 5b). Reference number 20 denotes a liquid-crystal panel functioning as an image display element. Reference number 21 denotes polarization-converted, color-split, and polarized incident color light of either red (R), green (G), or blue (B). Symbol X-X′ denotes a linear polarization direction of the incident light 21. The incident-light polarizing plate 4 and the exit-light polarizing plate 5 have the polarizing films 4a and 5a disposed at positions close to the liquid-crystal panel 20 with respect to the magnesium oxide substrates 4b and 5b, respectively. The polarizing films 4a and 5a are adapted to have their light-transmitting axes shifted through about 90° with respect to each other. The incident-light polarizing plate 4 and the exit-light polarizing plate 5 are each arranged with a required specific spacing with respect to the liquid-crystal panel 20.

In the above configuration, the polarized incident light 21 that is P-polarized or S-polarized color light passes through the magnesium oxide substrate 4b of the incident-light polarizing plate 4 and then enters the polarizing film 4a. The polarizing film 4a transmits, among the entire polarized light, only the light components having the desired polarization directivity. The polarized light, after passing through the polarizing film 4a, is directed onto the liquid-crystal panel 20. The polarized light that has thus been directed onto the liquid-crystal panel 20 undergoes light modulation based on an image signal. After being light-modulated, the polarized color light enters the polarizing film 5a of the exit-light polarizing plate 5. The polarizing film 5a transmits, among the entire polarized light, only the light components having the desired polarization directivity. The polarized light, after passing through the polarizing film 5a, further passes through the magnesium oxide substrate 5b and then enters the next-stage side of the optical system formed in the present configuration. The polarizing film 4a has a light-transmitting axis in the X-X′ direction, and the polarizing film 5a has a light-transmitting axis in a direction perpendicular to the X-X′ direction.

Since the magnesium oxide substrates 4b and 5b both have a cubic structure, these substrates cause neither double refraction nor a change from linearly polarized light into elliptically polarized light. For these reasons, light is not absorbed or lost too much in the polarizing films 4a, 5a, and a bright, high-contrast image can be obtained. In addition, since the magnesium oxide substrates 4b and 5b both have a cubic structure as mentioned above, neither of the substrates has directivity, even with respect to the direction of the light-transmitting axis (light-absorbing axis) of the polarizing film 4a, 5a. Neither substrate, therefore, requires direction matching to the light-transmitting axis (light-absorbing axis) of the polarizing film 4a, 5a. Furthermore, the magnesium oxide substrate 4b, 5b, because of its heat-releasing property, releases the heat occurring in the substrate itself and in the polarizing film 4a, 5a. Increases in a temperature of the incident-light polarizing plate 4 or of the exit-light polarizing plate 5 are thus suppressed. Magnesium oxide has a thermal conductivity of about 55 W/m·k, which is higher than a thermal conductivity of sapphire (about 42 W/m·k). As the magnesium oxide substrate 4b, 5b increases in plate thickness (substrate thickness), the substrate releases a greater amount of heat. In the present embodiment, the approximate plate thicknesses of the magnesium oxide substrates 4b and 5b range from 0.4×10⁻³ to 1.5×10⁻³ m.

FIG. 2 shows a configurational example of the projection-type image display apparatus employing the polarizing plates of FIG. 1.

In FIG. 2, reference number 1 denotes a light source unit 6, a first array lens including a plurality of very small lens cells and forming a plurality of secondary light source images, and 7, a second array lens also including a plurality of very small lens cells and converging individual lens images of the first array lens. A polarization conversion element 8 includes a polarized-light beam splitter (not shown) and a ½λ retardation plate (not shown). Reference number 3 denotes a polarization conversion element or a polarization converter, which, after receiving light from the second array lens and splitting the light into P-polarized light and S-polarized light, aligns either the P-polarized or S-polarized light by rotating the polarization direction thereof. The light, after being aligned, exits the polarization conversion element 8. Reference number 9 denotes a condensing lens, 12 and 13, both a dichroic mirror as a color splitter for color splitting, 10R, 10G, and 10B, each a condenser lens, 14, 15, 16, each a reflecting mirror, and 17 and 18, both a relay lens. Reference numbers 20R, 20G, 20B each denote a transmissive liquid-crystal panel operating as an image display element. Reference number 4R denotes an incident-light polarizing plate operating as a polarizing element for the liquid-crystal panel 20R. Reference number 5R denotes an exit-light polarizing plate operating as another polarizing element for the liquid-crystal panel 20R. Reference number 4G denotes an incident-light polarizing plate operating as a polarizing element for the liquid-crystal panel 20G. Reference number 5G denotes an exit-light polarizing plate operating as another polarizing element for the liquid-crystal panel 20G. Reference number 4B denotes an incident-light polarizing plate operating as a polarizing element for the liquid-crystal panel 20B. Reference number 5B denotes an exit-light polarizing plate operating as another polarizing element for the liquid-crystal crystal panel 20B. Reference number 11 denotes a dichroic prism functioning as a color synthesizer for color synthesizing, 8 a projection lens unit for enlarging and projecting image light, 19 a screen, 26 a cooling fan, and 27 a flow path for cooling air. The incident-light polarizing plates 4R, 4G, 4B, and the exit-light polarizing plates 5R, 5G, 5B each have the constituent elements shown in FIG. 1. The liquid-crystal panels 20R, 20G, 20B are each driven by a driving circuit (not shown) on the basis of an image signal, and each of the panels modulates polarized incident light and then causes the light to exit. The relay lenses 17, 18 are provided to compensate for the fact that an optical-path length of the liquid-crystal panel 20B from the light source unit 1 is greater than that of the liquid-crystal panel 20R, 20G. The above-mentioned optical elements from the light source 1 to the projection unit 3 constitute the optical unit included in the projection-type image display apparatus.

In this configuration, white light that has been emitted from the light source 1 first forms multiple primary light source images on the first array lens 6 and then converges the multiple primary light source images on the second array lens 7. The thus-converged image light is then split into P-polarized light and S-polarized light by the polarized-light beam splitter (not shown) inside the polarization conversion element 8. Next, the P-polarized light, for example, has its polarization direction rotated by the ½λ retardation plate (not shown) to become S-polarized light. The S-polarized light then enters the condensing lens 9 along with the S-polarized light that was obtained from splitting by the polarized-light beam splitter. The S-polarized light components of the white light that have been condensed by the condensing lens 9 enter the dichroic mirror 12 at an incident angle of about 45°. On the dichroic mirror 12, S-polarized light components of red light are reflected and S-polarized light components of green light and blue light are passed through.

The reflected S-polarized light components of the red light are further reflected by the reflecting mirror 14, on which an optical path of the S-polarized light components is then changed and the light components enter the incident-light polarizing plate 4R of the transmissive liquid-crystal panel 20R for red light, via the condenser lens 10R. The light components of the S-polarized red light that travels in the same direction as that of the light-transmitting axis of the incident-light polarizing plate 4R are passed therethrough. The S-polarized red light is thus aligned in the same polarization direction and then directed onto the transmissive liquid-crystal panel 20R for red light. On the liquid-crystal panel 20R, the S-polarized red light, when passing through the panel 20R, is modulated in accordance with an image signal and then exits as P-polarized red light. After exiting the liquid-crystal panel 20R, the P-polarized red light enters the exit-light polarizing plate 5R. The light components of the P-polarized red light that travel in the same direction as that of the light-transmitting axis of the exit-light polarizing plate 5R are then passed therethrough. The P-polarized red light is thus aligned in the same polarization direction and then enters the dichroic prism 11. The dichroic prism 11 reflects the light on its dichroic surface, and the reflected light enters the projection lens unit 3.

Meanwhile, the S-polarized green light and blue light components that have passed through the dichroic mirror 12 further enter the dichroic mirror 13 at an incident angle of about 45°. On the dichroic mirror 13, the S-polarized green light is reflected and the S-polarized blue light is passed through. The reflected S-polarized green light goes through the condenser lens 10G and enters the incident-light polarizing plate 4G of the transmissive liquid-crystal panel 20G for green light.

The light components of the S-polarized green light that travel in the same direction as that of the light-transmitting axis of the incident-light polarizing plate 4G are passed therethrough. The S-polarized green light is thus aligned in the same polarization direction and then directed onto the transmissive liquid-crystal panel 20G for green light. On the liquid-crystal panel 20G, the S-polarized green light, when passing through the panel 20G, is modulated in accordance with an image signal and then exits as P-polarized green light. After exiting the liquid-crystal panel 20G, the P-polarized green light enters the exit-light polarizing plate 5G. The light components of the P-polarized green light that travel in the same direction as that of the light-transmitting axis of the exit-light polarizing plate 5G are then passed therethrough. The P-polarized green light is thus aligned in the same polarization direction and then enters the dichroic prism 11. The P-polarized green light is reflected from a dichroic surface in the dichroic prism 11, and the reflected light enters the projection lens unit 3.

In addition, S-polarized blue light that has passed through the dichroic mirror 13 goes through the relay lens 17 and is then reflected by the reflecting mirror 15. The S-polarized blue light, after further going through the relay lens 18 and being reflected by the reflecting mirror 16, enters the incident-light polarizing plate 4B of the transmissive liquid-crystal panel 20B for blue light, via the condenser lens 10B. The light components of the S-polarized blue light that travel in the same direction as that of the light-transmitting axis of the incident-light polarizing plate 4B are also passed therethrough. The S-polarized blue light is thus aligned in the same polarization direction and then directed onto the transmissive liquid-crystal panel 20B for blue light. On the liquid-crystal panel 20B, the S-polarized blue light, when passing through the panel 20B, is modulated in accordance with an image signal and then exits as P-polarized blue light. After exiting the liquid-crystal panel 20B, the P-polarized blue light enters the exit-light polarizing plate 5B. The light components of the P-polarized blue light that travel in the same direction as that of the light-transmitting axis of the exit-light polarizing plate 5G are then passed therethrough. The P-polarized blue light is thus aligned in the same polarization direction and then enters the dichroic prism 11. The P-polarized blue light is reflected from the dichroic surface in the dichroic prism 11, and the reflected light enters the projection lens unit 3.

That is to say, as described above, the P-polarized red light, P-polarized green light, and P-polarized blue light that were each modulated using an image signal are mutually color-synthesized into white light and go out from the dichroic prism 11. After this, the P-polarized white light enters the projection lens unit 3, from which the light is then projected as image light in an enlarged form onto the screen 19.

In the above configuration, on the incident-light polarizing plates 4R, 4G, 4B, and the exit-light polarizing plates 5R, 5G, 5B, light that cannot pass through the light-transmitting axes of the respective polarizing films is transformed into heat by being absorbed thereinto to increase the polarizing films in temperature. The magnesium oxide substrate, because of its heat-releasing property (thermal conductivity), releases the internal heat of the associated polarizing film, thus suppressing increases in the temperature of the entire associated polarizing film/polarizing plate structure. The cooling fan 26 uses a cooling duct (not shown) to form the flow path 27, and then blows cooling air to the incident-light polarizing plates 4R, 4G, 4B, the exit-light polarizing plates 5R, 5G, 5B, the liquid-crystal panels 20R, 20G, 20R, and other elements. The cooling air flows through spatial voids present between the incident-light polarizing plates 4R, 4G, 4B, and the liquid-crystal panels 20R, 20G, 20R, respectively. Likewise, it flows through the voids between the exit-light polarizing plates 5R, 5G, 5B and the liquid-crystal panels 20R, 20G, 20R, respectively. Thus, the cooling air cools each of these elements. Heat of the incident-light polarizing plates 4R, 4G, 4B, and the exit-light polarizing plates 5R, 5G, 5B, is released from the respective magnesium oxide substrates into the cooling air, whereby a heat-releasing effect is enhanced by the flow of the air.

While, in the above configurational example, polarization conversion is followed by exit of S-polarized light from the polarized-light conversion element 8, the present invention is not limited to this example and P-polarized light may be caused to exit after the conversion. In this case, P-polarized R, B, G color light components are passed through the incident-light polarizing plates 4R, 4G, 4B, and directed onto the liquid-crystal panels 20R, 20G, 20R, respectively. In the liquid-crystal panels 20R, 20G, 20R, the P-polarized light is modulated in accordance with an image signal during passage through each panel, then the light exits as S-polarized R, G, B color light from the panel, and is color-synthesized by sent to the dichroic prism 11.

In the configurational examples of FIGS. 1, 2, one liquid-crystal panel has, on the incident side thereof, one incident-light polarizing plate with a polarizing film on one face of a magnesium oxide substrate, and on the exit side of the panel, one exit-light polarizing plate with a polarizing film on one face of a magnesium oxide substrate. However, the present invention is not limited to these configurations. For example, the liquid-crystal panel may have, on the exit side thereof, one exit-light polarizing plate with a polarizing film on both faces of one magnesium oxide substrate, or two exit-light polarizing plates each with a polarizing film on one face of a magnesium oxide substrate.

FIG. 3 shows an example of simulation results on contrast and polarizing plate temperature characteristics of the magnesium oxide substrate of a polarizing plate with respect to a substrate thickness thereof. Because of their cubic structure, magnesium oxide substrates normally do not cause double refraction. However, if a subgrain boundary is caused by nonuniform crystal growth or if a stress is applied during machining/processing, the resulting phase difference may result in double refraction occurring. The present invention allows for the occurrence of this event. Measurements on a sample in which the above phase difference actually occurred were performed to find that the phase difference ranged from about 0.5×10⁻⁹ to 1.0×10⁻⁹ m. Contrast was therefore simulated with nonuniform polarization (phase difference) per 1×10⁻³ m of a substrate thickness taken as 1×10⁻⁹ m.

In FIG. 3, contrast decreases since the nonuniformity of polarization increases with increases in the plate thickness of the magnesium oxide substrate. For an initial contrast value of 500:1, the plate thickness range of magnesium oxide substrates that satisfies a contrast value equal to or greater than 460:1, i.e., about 90% of the above value, is up to about 2.0×10⁻³ m. Likewise, the plate thickness range of magnesium oxide substrates that satisfies a contrast value equal to or greater than 480:1, i.e., about 96% of the above value, is up to about 1.5×10⁻³ m. The temperature of the polarizing plate also decreases since the amount of heat released by the magnesium oxide substrate increases with increases in its plate thickness. The plate thickness range of magnesium oxide substrates that reduces the temperature of the polarizing plate to 75° C. or less is up to about 0.3×10⁻³ m. The plate thickness range of magnesium oxide substrates that reduces the temperature of the polarizing plate to 70° C. or less is up to about 0.4×10⁻³ m. Therefore, the plate thickness range of magnesium oxide substrates that reduces the temperature of the polarizing plate to 75° C. or less for a contrast value of 460:1 or more is from about 0.3×10⁻³ m to about 2.0×10⁻³ m. Similarly, the plate thickness range of magnesium oxide substrates that reduces the temperature of the polarizing plate to 70° C. or less for a contrast value of 480:1 or more is from about 0.4×10⁻³ m to about 1.5×10⁻³ m.

According to the above first embodiment of the present invention, it is possible to ensure high contrast and at the same time to suppress increases in the temperatures of polarizing means (polarizing plates). Since the incident-light polarizing plate 4 and the exit-light polarizing plate 5, in particular, use the magnesium oxide substrates 4b and 5b, respectively, these substrates do not require direction matching to the light-transmitting axes (light-absorbing axes) of the polarizing films 4a and 5a. The use of the above substrates also makes it possible to improve manufacturing efficiency of each polarizing plate significantly, thus reducing costs.

FIGS. 4 to 7 are explanatory diagrams of a second embodiment. In the second embodiment, a viewing-angle compensating means that compensates for any phase differences of light is further provided between an image display element and polarizing means. In FIGS. 4 to 7, the same reference number as used in FIGS. 1 and 2 is assigned to the same constituent element as used therein.

FIG. 4 is a diagram showing a first combination configurational example of polarizing means and viewing-angle compensating means. In this example, two viewing-angle compensating means are arranged on the exit side of an image display element.

In FIG. 4, reference number 50 denotes a first viewing-angle compensating plate functioning as a viewing-angle compensating means, and 50a denotes a viewing-angle compensating film that compensates for any phase differences of light by transmitting the light. Reference number 50b denotes a substrate of the first viewing-angle compensating plate 50. The substrate 50b as a light-transmissive substrate having a cubic structure, is constructed of a material that contains magnesium oxide, and holds the viewing-angle compensating film 50a (hereinafter, the substrate 50b is referred to as the magnesium oxide substrate 50b). Reference number 60 denotes a second viewing-angle compensating plate functioning as a viewing-angle compensating means, and 60a a viewing-angle compensating film that compensates for any phase differences of light by transmitting the light. Reference number 60b denotes a substrate of the second viewing-angle compensating plate 60. The substrate 60b as a light-transmissive substrate having a cubic structure, is constructed of a material that contains magnesium oxide, and holds the viewing-angle compensating film 60a (hereinafter, the substrate 60b is referred to as the magnesium oxide substrate 60b). The viewing-angle compensating films 5a, 60a are formed so that respective optical axes are approximately orthogonal to each other and so that a positional shift of at least one of the two optical axes, with respect to a rubbing direction of a liquid-crystal panel 20, stays within a range of about ±1°. The viewing-angle compensating plate 50 or 60 is adapted so that a shift in the position of the optical axis of the viewing-angle compensating film 50a or 60a with respect to the rubbing direction of the liquid-crystal panel 20 can be adjusted to a required value by changing an installation state of the associated substrate 50b or 60b. Both the first viewing-angle compensating plate 50 and the second viewing-angle compensating plate 60 have the respective viewing-angle compensating films 50a, 60a arranged at positions close to the liquid-crystal panel 20 with respect to the magnesium oxide substrates 50b, 60b, respectively. Both an incident-light polarizing plate 4 and an exit-light polarizing plate 5, as polarizing elements, also have polarizing films 4a, 5a arranged at positions close to the liquid-crystal panel 20 with respect to the magnesium oxide substrates 4b, 5b, respectively. The polarizing films 4a, 5a are formed so that respective light-transmitting axes shift through about 90° with respect to each other. The incident-light polarizing plate 4 and the liquid-crystal panel 20, and the liquid-crystal panel 20 and the first viewing-angle compensating plate 50 are each arranged with a required specific spacing with respect to each other. Similarly, the first viewing-angle compensating plate 50 and the second viewing-angle compensating plate 60, and the second viewing-angle compensating plate 60 and the exit-light polarizing plate 5 are each arranged with a required specific spacing with respect to each other.

In the above configuration, P-polarized or S-polarized incident color light 21 passes through the magnesium oxide substrate 4b of the incident-light polarizing plate 4 and then enters the polarizing film 4a. The polarizing film 4a transmits, among the entire polarized color light, only light components with desired polarization directivity. Polarized light from the polarizing film 4a is directed onto the liquid-crystal panel 20. The polarized light that has thus been directed onto the liquid-crystal panel 20 undergoes light modulation based on an image signal. The polarized light that has been light-modulated enters the first viewing-angle compensating plate 50, and after having any phase differences compensated for by the viewing-angle compensating film 50a, passes through the magnesium oxide substrate 50b. The polarized light whose phase differences have been compensated for by the first viewing-angle compensating plate 50 further enters the second viewing-angle compensating plate 60. The polarized light also has its phase differences compensated for in the second viewing-angle compensating plate 60 by the viewing-angle compensating film 60a, and then passes through the magnesium oxide substrate 60b. The polarized light whose phase differences have been compensated for by the second viewing-angle compensating plate 60 enters the exit-light polarizing plate 5 of the next-stage. At the exit-light polarizing plate 5, the polarizing film 5a transmits, among the entire polarized light, only light components with desired polarization directivity. The polarized light, after passing through the polarizing film 5a, further passes through the magnesium oxide substrate 5b. The polarizing film 4a has a light-transmitting axis in an X-X′ direction, and the polarizing film 5a has a light-transmitting axis in a direction perpendicular to the X-X′ direction.

Since the magnesium oxide substrates 4b, 5b, 50b, 60b each have a cubic structure, these substrates cause neither double refraction nor a change from linearly polarized light into elliptically polarized light. For these reasons, light is not absorbed or lost too much in the polarizing films 4a, 5a, and the viewing-angle compensating films 50a, 60a, and a bright, high-contrast image can be obtained. The viewing-angle compensating films 50a, 60a, in particular, significantly improve the contrast level of the image by compensating for any phase differences of the light. In addition, since the magnesium oxide substrates 4b, 5b, 50b, 60b each have a cubic structure as mentioned above, neither of the substrates has directivity, even with respect to the directions of the light-transmitting axes (light-absorbing axes) of the polarizing film 4a, 5a, and the viewing-angle compensating film 50a, 60a. Neither substrate, therefore, requires direction matching to the light-transmitting axes (light-absorbing axes) of the polarizing film 4a, 5a, and the viewing-angle compensating film 50a, 60a. Furthermore, the magnesium oxide substrate 4b, 5b, 50b, 60b, because of its heat-releasing property, releases the heat occurring in the substrate itself and in the polarizing film 4a, 5a, and the viewing-angle compensating film 50a, 60a. This suppresses increases in temperatures of the incident-light polarizing plate 4 or the exit-light polarizing plate 5 and of the first viewing-angle compensating plate 50 or the second viewing-angle compensating plate 60. As the magnesium oxide substrate. 4b, 5b, 50b, 60b increases in plate thickness (substrate thickness), the substrate releases a greater amount of heat. In the present embodiment, the approximate plate thicknesses of the magnesium oxide substrates 4b, 5b, 50b, 60b range from 0.4×10⁻³ to 1.5×10⁻³ m so as to satisfy the characteristics shown in FIG. 3. It is thus possible to suppress increases in the temperatures of the incident-light polarizing plate 4, the exit-light polarizing plate 5, the first viewing-angle compensating plate 50, and the second viewing-angle compensating plate 60, and to ensure high contrast.

FIG. 5 shows simulation results on a relationship between contrast and an optical-axis shift of the viewing-angle compensating film of a viewing-angle compensating plate with respect to the rubbing direction of the liquid-crystal panel 20 in the configuration of FIG. 4. An optical-axis adjustment angle of the viewing-angle compensating film is plotted on a horizontal axis, and contrast, on a vertical axis. The simulation assumes that the optical axis of the viewing-angle compensating film is shifted through 1° with respect to the rubbing direction of the liquid-crystal panel 20 beforehand. The simulation also assumes that the cubic-structured light-transmissive magnesium oxide substrate 4b, 5b, 50b, 60b has a plate thickness from about 0.5×10⁻³ m to about 0.7×10⁻³ m. The characteristics curve obtained using sapphire substrates as the incident-light polarizing plate 4, the exit-light polarizing plate 5, the first viewing-angle compensating plate 50, and the second-viewing-angle compensating plate 60, is also shown for comparison in FIG. 5. For the viewing-angle compensating plates made of sapphire, since the sapphire substrate has a double refraction property, if an optical axis of the sapphire substrate inclines with respect to a proximate polarizing plate, contrast decreases at a high rate with respect to the inclination. For the magnesium oxide substrate, however, such a decrease does not occur because of the cubic structure. Compared with the sapphire substrate, the magnesium oxide substrate yields a significantly high contrast level at any angle offset (shift) positions. Also, provided that the plate thickness of the magnesium oxide substrate ranges from about 0.3×10⁻³ m to about 2.0×10⁻³ m, effects of any phase differences resulting from as measured nonuniform product characteristics can be ignored in terms of practical use. Contrast can therefore be improved by performing angle adjustments on the optical axis of either the viewing-angle compensating film 50a or 60a so that matching of the optical axis to the rubbing direction of the liquid-crystal panel 20 is realized within a required range.

The simulation results in FIG. 5 indicate that when one of the approximately orthogonal optical axes of the viewing-angle compensating films 50a, 60a is matched to the rubbing direction of the liquid-crystal panel 20 (i.e., when the adjusting angle of the viewing-angle compensating film is 1°), image contrast is maximized to about 1000:1. The contrast is improved to at least about 800:1 if the above offset of the optical axis from the corresponding maximum point position is within a range of ±1°.

The incident-light polarizing plate 4, exit-light polarizing plate 5, first viewing-angle compensating plate 50, and second viewing-angle compensating plate 60 of FIG. 4 may be used instead of the incident-light polarizing plate 4R, exit-light polarizing plate 5R, incident-light polarizing plate 4G, exit-light polarizing plate 5G, incident-light polarizing plate 4B, and exit-light polarizing plate 5B used in the projection-type image display apparatus of above FIG. 2. It is thus possible to construct a projection-type image display apparatus that suppresses increases in the temperatures of each polarizing plate and each viewing-angle compensating plate and is improved, in brightness and contrast. In this projection-type image display apparatus, optical elements from a light source 1 to a projection unit 3 also constitute the optical unit included in the projection-type image display apparatus. In this projection-type image display apparatus or in its optical unit, the first viewing-angle compensating plate 50 and the second viewing-angle compensating plate 60 are constructed so that either one or both of the magnesium oxide substrates 50b, 60b make installation states of the above two compensating plates adjustable. The viewing-angle compensating plates 50, 60 are also adapted so that by adjusting the installation states thereof, positional shifts (offsets) of either one or both of the viewing-angle compensating films 50a, 60a, with respect to a rubbing direction of the liquid-crystal panel 20, can be adjusted to stay within a required range.

FIG. 6 is a diagram showing a second combination configurational example of polarizing means and viewing-angle compensating means. In this example, one set of viewing-angle compensating means each with a viewing-angle compensating film on both faces of a substrate are arranged on the exit side of an image display element.

In FIG. 6, reference number 50═ denotes a viewing-angle compensating plate functioning as a viewing-angle compensating means, and 50a₁ and 50a₂ denote viewing-angle compensating films that compensate for any phase differences of light by transmitting the light. Reference number 50b denotes a substrate of the viewing-angle compensating plate 50′. The substrate 50b as a light-transmissive substrate having a cubic structure, is constructed of a material that contains magnesium oxide, and holds the viewing-angle compensating film 50a₁, 50a₂ provided on both faces of the substrate (hereinafter, the substrate 50b is referred to as a magnesium oxide substrate). The viewing-angle compensating films 50a₁, 50a₂ are formed so that the respective optical axes thereof are approximately orthogonal to each other and so that a positional shift of at least one of the two optical axes, with respect to a rubbing direction of a liquid-crystal panel 20, stays within a range of about ±1°. The viewing-angle compensating plate 50′ is adapted so that a shift in the position of the optical axis of the viewing-angle compensating film 50a₁ or 50a₂ with respect to the rubbing direction of the liquid-crystal panel 20 can be adjusted to a required value by changing an installation state of the substrate 50b. An incident-light polarizing plate 4 and an exit-light polarizing plate 5, each functioning as a polarizing means, also use magnesium oxide substrates 4b and 5b, as the substrates that hold polarizing films 4a and 5a, respectively. The polarizing films 4a, 5a are formed so that the respective light-transmitting axes thereof shift through about 90° with respect to each other. The incident-light polarizing plate 4 and the liquid-crystal panel 20, and the liquid-crystal panel 20 and the viewing-angle compensating plate 50′ are each arranged with a required specific spacing with respect to each other. Similarly, the viewing-angle compensating plate 50′ and the exit-light polarizing plate 5 are arranged with a required specific spacing with respect to each other.

In the above configuration, P-polarized or S-polarized incident color light 21 passes through the magnesium oxide substrate 4b of the incident-light polarizing plate 4 and then enters the polarizing film 4a. The polarizing film 4a transmits, among the entire polarized color light, only light components with desired polarization directivity. Polarized light from the polarizing film 4a is directed onto the liquid-crystal panel 20. The polarized light that has thus been directed onto the liquid-crystal panel 20 undergoes light modulation based on an image signal. The polarized light that has been light-modulated enters the viewing-angle compensating plate 50′, and after having any phase differences compensated for by the viewing-angle compensating film 50a₁, passes through the magnesium oxide substrate 50b. The polarized light further enters the viewing-angle compensating film 50a₂. The polarized light also has its phase differences compensated for therein, and then enters the exit-light polarizing plate 5. At the exit-light polarizing plate 5, the polarizing film 5a transmits, among the entire polarized light, only light components with desired polarization directivity. The polarized light, after passing through the polarizing film 5a, further passes through the magnesium oxide substrate 5b. In this configuration, as in the foregoing configuration, the polarizing film 4a has a light-transmitting axis in an X-X′ direction, and the polarizing film 5a has a light-transmitting axis in a direction perpendicular to the X-X′ direction.

In the configuration of FIG. 6, a bright, high-contrast image can also be obtained since each of the magnesium oxide substrates 4b, 5b, 50b has a cubic structure. The viewing-angle compensating-films 50a₁, 50a₂, in particular, significantly improve the image in contrast level. In addition, the magnesium oxide substrates 4b, 5b, 50b do not require direction matching to the light-transmitting axes (light-absorbing axes) of the polarizing films 4a, 5a, or to those of the viewing-angle compensating films 50a₁, 50a₂, since neither substrate has directivity, even with respect to the directions of the above light-transmitting axes (light-absorbing axes). Furthermore, the magnesium oxide substrate 4b, 5b, 50b, because of its heat-releasing property, suppresses increases in temperatures of the incident-light polarizing plate 4, the exit-light polarizing plate 5, and the viewing-angle compensating plate 50′ each, by releasing the heat occurring therein. The approximate plate thicknesses of the magnesium oxide substrates 4b, 5b, 50b range from 0.4×10⁻³ to 1.5×10⁻³ m so as to satisfy the characteristics shown in FIG. 3. It is thus possible to suppress increases in the temperatures of the incident-light polarizing plate 4, the exit-light polarizing plate 5, and the viewing-angle compensating plate 50′, and to ensure high contrast.

The incident-light polarizing plate 4, exit-light polarizing plate 5, and viewing-angle compensating plate 50′ of FIG. 6 may be used instead of the incident-light polarizing plate 4R, exit-light polarizing plate 5R, incident-light polarizing plate 4G, exit-light polarizing plate 5G, incident-light polarizing plate 4B, and exit-light polarizing plate 5B used in the projection-type image display apparatus of above FIG. 2. It is thus possible to construct a projection-type image display apparatus that suppresses increases in the temperatures of each polarizing plate and each viewing-angle compensating plate and is improved in brightness and contrast. In this projection-type image display apparatus, optical elements from a light source 1 to a projection unit 3 also constitute the optical unit included in the projection-type image display apparatus. In this projection-type image display apparatus or in its optical unit, the viewing-angle compensating plate 50′ is constructed so that the magnesium oxide substrate 50b makes an installation state of the viewing-angle compensating plate 50′ adjustable. The viewing-angle compensating plate 50′ is also adapted so that by adjusting the installation state thereof, positional shifts (offsets) of either one or both of the viewing-angle compensating films 50a₁, 50a₂, with respect to a rubbing direction of the liquid-crystal panel 20, can be adjusted to stay within a required range.

FIG. 7 is a diagram showing a third combination configurational example of polarizing means and viewing-angle compensating means. In this example, two viewing-angle compensating elements each with a viewing-angle compensating film on both faces of a substrate are arranged independently at the incident side and exit side each of an image display element.

In FIG. 7, reference number 50 denotes a first viewing-angle compensating plate disposed as a viewing-angle compensating means on the incident side of the image display element, and 60 a second viewing-angle compensating plate disposed as a viewing-angle compensating means on the exit side of the image display element. Viewing-angle compensating films 50a, 60a are formed so that the respective optical axes thereof are approximately orthogonal to each other and so that a positional shift of at least one of the two optical axes, with respect to a rubbing direction of a liquid-crystal panel 20, stays within a range of about ±1°. The first viewing-angle compensating plate 50 has a magnesium oxide substrate 50b that operates as a light-transmissive substrate having a cubic structure. The second viewing-angle compensating plate 60 has a magnesium oxide substrate 60b that operates as a light-transmissive substrate also having a cubic structure. The first viewing-angle compensating plate 50 or the second viewing-angle compensating plate 60 is adapted so that a shift in the position of the optical axis of the viewing-angle compensating film 50a or 60a with respect to the rubbing direction of the liquid-crystal panel 20 can be adjusted to a required value by changing an installation state of the associated substrate 50b, 60b. The first viewing-angle compensating plate 50 and the second viewing-angle compensating plate 60 have viewing-angle compensating films 50a, 60a arranged at positions close to the liquid-crystal panel 20 with respect to the magnesium oxide substrates 50b, 60b, respectively. Both an incident-light polarizing plate 4 and an exit-light polarizing plate 5, as polarizing means, also have respective polarizing films 4a, 5a arranged at positions close to the liquid-crystal panel 20 with respect to the magnesium oxide substrates 50b, 60b, respectively. The polarizing films 4a and 5a are formed so that the respective light-transmitting axes thereof shift through about 90° with respect to each other. The incident-light polarizing plate 4 and the first viewing-angle compensating plate 50, the first viewing-angle compensating plate 50 and the liquid-crystal panel 20, the liquid-crystal panel 20 and the second viewing-angle compensating plate 60 are each arranged with a required specific spacing with respect to each other. Similarly, the second viewing-angle compensating plate 60 and the exit-light polarizing plate 5 are arranged with a required specific spacing with respect to each other.

In the above configuration, P-polarized or S-polarized incident color light 21 passes through the magnesium oxide substrate 4b of the incident-light polarizing plate 4 and then enters the polarizing film 4a. The polarizing film 4a transmits, among the entire polarized color light, only light components with desired polarization directivity. Polarized light from the polarizing plate 4 enters the first viewing-angle compensating plate 50, and after the polarized light has passed through the magnesium oxide substrate 50b, any phase differences of the light are compensated for by the viewing-angle compensating film 50a. After this, the polarized light is directed onto the liquid-crystal panel 20 and undergoes light modulation based on an image signal. The polarized light that has thus been light-modulated enters the viewing-angle compensating plate 60 and after having any phase differences compensated for by the viewing-angle compensating film 60a, passes through the magnesium oxide substrate 60b. The polarized light that has exited the second viewing-angle compensating plate 60 enters the exit-light polarizing plate 5. At the exit-light polarizing plate 5, of the entire polarized light, only components with desired polarization directivity have their passage selected by the polarizing film 5a. The polarized light whose passage has thus been selected further passes through the magnesium oxide substrate 5b and enters the next-stage side of the optical system including a color-synthesizing element and other elements. In this configuration, as in the foregoing configurations, the polarizing film 4a has a light-transmitting axis in an X-X′ direction, and the polarizing film 5a has a light-transmitting axis in a direction perpendicular to the X-X′ direction.

In the configuration of FIG. 7, a bright, high-contrast image can also be obtained since each of the magnesium oxide substrates 4b, 5b, 50b has a cubic structure. The viewing-angle compensating films 50a, 60a, in particular, significantly improve the image in contrast level. In addition, the magnesium oxide substrates 4b, 5b, 50b do not require direction matching to the light-transmitting axes (light-absorbing axes) of the polarizing films 4a, 5a, or to those of the viewing-angle compensating film 50a, 60a, since neither substrate has directivity, even with respect to the directions of the above light-transmitting axes (light-absorbing axes). Furthermore, the magnesium oxide substrate 4b, 5b, 50b, because of its heat-releasing property, releases the heat occurring in the incident-light polarizing plate 4, the exit-light polarizing plate 5, the first viewing-angle compensating plate 50, and the second viewing-angle compensating plate 60. Increases in temperatures of these elements are thus suppressed. Approximate plate thicknesses of the magnesium oxide substrates 4b, 5b, 50b range from 0.4×10⁻³ to 1.5×10⁻³ m so as to satisfy the characteristics shown in FIG. 3. It is thus possible to suppress increases in the temperatures of the incident-light polarizing plate 4, the exit-light polarizing plate 5, the first viewing-angle compensating plate 50, and the second viewing-angle compensating plate 60, and to ensure high contrast.

The incident-light polarizing plate 4, exit-light polarizing plate 5, first viewing-angle compensating plate 50, and second viewing-angle compensating plate 60 of FIG. 7 may be used instead of the incident-light polarizing plate 4R, exit-light polarizing plate 5R, incident-light polarizing plate 4G, exit-light polarizing plate 5G, incident-light polarizing plate 4B, and exit-light polarizing plate 5B used in the projection-type image display apparatus of FIG. 2. Thus, it is possible to construct a projection-type image display apparatus that suppresses increases in the temperatures of each polarizing plate and each viewing-angle compensating plate and is improved in brightness and contrast. In this projection-type image display apparatus, optical elements from a light source 1 to a projection unit 3 also constitute the optical unit included in the projection-type image display apparatus. In this projection-type image display apparatus or in its optical unit, either one or both of the viewing-angle compensating plates 50, 60 are constructed so that respective installation states can be adjusted via either one or both of the magnesium oxide substrates 50b, 60b. The above viewing-angle compensating plates are also adapted so that by adjusting the installation state thereof, positional shifts (offsets) of either one or both of the viewing-angle compensating films 50a, 60a, with respect to a rubbing direction of the liquid-crystal panel 20, can be adjusted to stay within a required range.

According to the second embodiment of the present invention, described above using FIGS. 4 to 7, it is possible to ensure high contrast and to suppress increases in the temperatures each of the incident-light polarizing plate 4, the exit-light polarizing plate 5, and the viewing-angle compensating plate 50, 50′, 60. Also, since the viewing-angle compensating plate 50, 50′, 60 are used, contrast, in particular, can be improved significantly. In addition, since the incident-light polarizing plate 4 and the exit-light polarizing plate 5 use the magnesium oxide substrates 4b and 5b, respectively, these magnesium oxide substrates do not require direction matching to the light-transmitting axes (light-absorbing axes) of the polarizing films 4a, 5a. Consequently, it is possible to improve each polarizing plate significantly in manufacturing efficiency and thus to reduce costs. Furthermore, since the magnesium oxide substrates 50b, 60b are used for the viewing-angle compensating plate 50, 50′, 60, the magnesium oxide substrates 50b, 60b do not require direction matching to the light-transmitting axes (light-absorbing axes) of the polarizing films 50, 50a₁, 50a₂, 60a. Consequently, it is possible to improve each viewing-angle compensating plate significantly in manufacturing efficiency and in terms of mountability in the optical system, and thus to reduce costs.

While, in each of the above embodiments, the description has been given of the projection-type image display apparatus using three liquid-crystal panels as image display elements, the present invention is not limited to such configurations and may take a configuration that uses one liquid-crystal panel as an image display element. The invention may otherwise take a configuration in which polarizing films and magnesium oxide substrates are spaced from each other as polarizing elements. Furthermore, the types of substrates used for polarizing means and viewing-angle compensating means are not limited to magnesium oxide substrates, any other light-transmissive material having a cubic structure and high thermal conductivity can be used instead.

1. An optical element for a projection image display apparatus, comprising:
a cubic-structured, light-transmissive substrate formed of magnesium oxide inclusive; and
an optical film disposed on said substrate.

2. The optical element according to claim 1, wherein:
said substrate has a thickness ranging from 0.4×10⁻³ to 1.5×10⁻³ m; and
said optical film is a polarizing film, and allows light with desired polarization direction to pass through.

3. The optical element according to claim 1, wherein:
said substrate has a thickness ranging from 0.4×10⁻³ to 1.5×10⁻³ m; and
said optical film is a viewing-angle compensating film, and compensates for a phase difference of the light passed therethrough.

4. A projection image display apparatus for forming an optical image modulating light irradiated from a light source onto an image display element in accordance with an image signal, said display apparatus comprising:
polarization conversion unit which approximately unifies polarization directions of the beams of light that are emitted from said light source, and thus forming polarized light components of desired polarization direction;
color-separating unit which separates the polarized light components into color light components of R, G, and B;
polarizing unit which is disposed at least on either a light-incident side or light-exit side of said image display element, and has a polarizing element on a cubic-structured, light-transmissive substrate formed of magnesium oxide inclusive, wherein said polarizing unit permits color light components with desired polarization direction to pass through;
color-synthesizing unit which synthesizes the optical image constructed of the polarized R, G, B color light components that are formed by said image display element; and
a projection lens unit which enlarges and projects the color-synthesized optical image.

5. The projection image display apparatus according to claim 4, wherein:
said substrate has a thickness ranging from 0.4×10⁻³ to 1.5×10⁻³ m.

6. A projection image display apparatus for forming an optical image modulating light irradiated from a light source onto an image display element in accordance with an image signal, said display apparatus comprising:
polarization conversion unit which approximately unifies polarization directions of the beams of light that are emitted from said light source, and thus forming polarized light components of desired polarization direction;
color-separating unit which separates the polarized light components into color light components of R, G, and B;
polarizing unit which is disposed at least on either a light-incident side or light-exit side of said image display element, and permits color light components with desired polarization direction to pass through; and
viewing-angle compensating unit which is disposed between said polarizing unit and said image display element, and has a viewing-angle compensating film on a cubic-structured, light-transmissive substrate formed of magnesium oxide inclusive, wherein said viewing-angle compensating unit compensates for phase differences of the polarized light incident on or exiting from said image display element.

7. The projection image display apparatus according to claim 6, wherein:
said substrate has a thickness ranging from 0.4×10⁻³ to 1.5×10⁻³ m.

8. The projection image display apparatus according to claim 6, wherein:
said polarizing unit has a polarizing element on a cubic-structured, light-transmissive second substrate formed of magnesium oxide inclusive.

9. The projection image display apparatus according to claim 7, wherein:
said polarizing unit has a polarizing element on a cubic-structured, light-transmissive second substrate formed of magnesium oxide inclusive.

10. The projection image display apparatus according to claim 8, wherein:
said second substrate has a thickness ranging from 0.4×10⁻³ to 1.5×10⁻³ m.

11. The projection image display apparatus according to claim 9, wherein:
said second substrate has a thickness ranging from 0.4×10⁻³ to 1.5×10⁻³ m.

12. The projection image display apparatus according to claim 6, wherein:
a difference between an optical axis of said viewing-angle compensating film and a rubbing direction of said image display element is within a range of about ±1°.

13. The projection image display apparatus according to claim 7, wherein:
a difference between an optical axis of said viewing-angle compensating film and a rubbing direction of said image display element is within a range of about ±1°.

14. The projection image display apparatus according to claim 8, wherein:
a difference between an optical axis of said viewing-angle compensating film and a rubbing direction of said image display element is within a range of about ±1°.

15. The projection image display apparatus according to claim 9, wherein:
a difference between an optical axis of said viewing-angle compensating film and a rubbing direction of said image display element is within a range of about ±1°.
